(19) United States
(12) Patent Application Publication
(10) Pub. No.: US 2008/0286193 A1
(43) Pub. Date: Nov. 20, 2008

(54) Chemical Regeneration of Activated Carbon

(76) Inventors: Luis R.S.M. Bento, Senhora da Hora (PT); Peter W. Rein, Stone (GB)

Correspondence Address: PATENT DEPARTMENT;TAYLOR, PORTER, BROOKS & PHILLIPS, L.L.P, P.O. BOX 2471, BATON ROUGE, LA, 70821-2471, US

(21) Appl. No.: 12/066,449

(22) PCT Filed: Sep. 8, 2006
(86) PCT No.: PCT/US06/34925

§ 371 Date: Jul. 16, 2008

Related U.S. Application Data
(60) Provisional application No. 60/717,410, filed on Sep. 14, 2005.

(51) Int. Cl. C01B 31/08

(52) U.S. Cl. 423/461

(57) ABSTRACT

A simple, economical process is disclosed for regenerating granular activated carbon, using a combination of alcohol, alkali, and oxidant, preferably ethanol, sodium hydroxide, and hydrogen peroxide. The regeneration process employs inexpensive compounds, is well-suited to be implemented on-site, and does not require spent carbon to be transported to a specialized facility for regeneration. The need for thermal regeneration of carbon, and its high energy consumption, are avoided.

(In countries other than the United States:) The benefit of the 14 Sep. 2005 filing date of U.S. patent application 60/717,410 is claimed under applicable treaties and conventions. (In the United States:) The benefit of the 14 Sep. 2005 filing date of provisional patent application 60/717,410 is claimed under 35 U.S.C. § 119(e).

### TECHNICAL FIELD

This invention pertains to the chemical regeneration of granular activated carbon.

### BACKGROUND ART

Granular activated carbon (GAC) is used in many purification processes. It has been used in sugar processing since the 1950s. GAC is used in the decolorization of sugar solutions, juices, syrups and liquors in cane, corn, and beet sugar and liquid sugar plants. It is also used in water filtration and purification, and other separation and purification processes. The enormous surface area-to-mass ratio typical of GAC permits the use of surprisingly small quantities to purify liquids or gases by mere contact. GAC impurity adsorption mechanisms include “physical” adsorption processes that do not involve the formation of chemical bonds, e.g., van der Waals, London and similar interactions, as well as hydrophobic interactions, ionic charge interactions, and size occlusion effects.

The existence of this array of non-specific adsorption mechanisms allows GAC to simultaneously capture impurities that have very different properties, e.g., differences in charge, electric dipole moment, polarizability, hydrophobicity, molecular weight, etc. However, after a period of use the GAC surface becomes occupied by adsorbed impurities, and its effectiveness decreases. It eventually becomes necessary to replace or regenerate the GAC.

Conventional regeneration techniques involve heating GAC to very high temperatures (T≈900° C.). This thermal process requires special handling equipment, storage silos, and an expensive kiln. On-site thermal processing is not economically justifiable in regions with short growing seasons. The alternative has often been to discard fouled GAC or to transport tons of GAC to specialized carbon kiln facilities dedicated to the thermal regeneration process. The thermal process also has significant environmental impact and economic consequences:
1. Large amounts of energy are required for kiln operation; substantial amounts of CO₂ are released into the environment;
2. GAC adsorbates are released into the atmosphere in reactive, oxidized and partially-oxidized states;
3. The heated GAC bed releases particulate matter and other pollutants into the atmosphere; and
4. Some GAC is lost in the process, both through oxidation and through mechanical degradation to unusably-small GAC particles.

Thermal GAC regeneration is the only industrial-scale GAC regeneration process currently used in the sugar industry. There is an unfilled need for improved GAC regeneration methods that have lower energy costs, reduced environmental impact, and that are easier to implement on-site without requiring transport to an off-site facility.

There have been prior reports on regenerating spent GAC in the sugar industry by washing with sodium hydroxide solutions, including B. Barker et al., “Colour removal with the SAPARAC Process—Preliminary results,” Proc. of South S. African Sugar Technol. Assoc., 76, 490-494; (2002); B. Barker et al., “Evaluation of chemically activated carbon (SPARAC) for sugar decolorizing,” Int. Sugar Journal, 106, 1266, 246-353 (2004); H. Kato et al., “Sugar refining with granular carbon regenerable with alkali,” Int. Sugar Journal, 95, 1139, 441-446, (1993); and M. Moodley et al., “Sugar decolourisation with regenerated activated carbon: Pilot plant evaluation at the Malelane Refinery,” Proc. Sugar Industry Technologists Inc. meeting, 47-66, (2000).

However, the performance of GAC regenerated by these prior chemical means has been below levels that are acceptable from a commercial standpoint. For example, the decolorization of sugar solutions using GAC regenerated by these prior chemical processes, when averaged over many cycles, has generally been below 53% (as reported in the literature cited above) (measured as decrease in color of the feed following GAC, in industry standard International Commission for Uniform Methods of Sugar Analysis (ICUMSA) units (IU)).

Other chemical GAC regeneration processes have focused on removing compounds such as dyestuffs or phenolics from industrial effluent. See, e.g., P. Li et al., “Adsorption and Desorption of Phenol on Activated Carbon Fibers in a Fixed Bed,” Separation Sci. Tech., 36, 2147-2163 (2001).

H. Nilsun et al., “Combination of activated carbon adsorption with light-enhanced chemical oxidation via hydrogen peroxide,” Water Research, 17, 4169-4176, (2000), disclose the purification of industrial effluent through the simultaneous use of GAC and hydrogen peroxide (H₂O₂).

N. Ince et al. (2000), “Combination of activated carbon adsorption with light-enhanced chemical oxidation via hydrogen peroxide,” Water Research 17:4169-4176 disclose the removal of impurities from effluent solutions by combining hydrogen peroxide, photolyzed under intense ultraviolet light, with adsorption onto a granular activated charcoal bed. The authors speculated that free radicals generated by H₂O₂ photolysis destroyed many organic contaminants before they were adsorbed on the GAC bed.

NOSB TAP Review (2002), available at www.omri.org/AC_processing.pdf (last visited Aug. 31, 2006), disclose that a number of solvents, acids, and alkalis may be employed to remove adsorbed substances from carbon. These include such things as carbon tetrachloride, hydrochloric acid, hydrogen peroxide, potassium hydroxide, and sodium hydroxide (p. 4). P. Li et al. (2001), “Adsorption and Desorption of Phenol on Activated Carbon Fibers in a Fixed Bed,” Separation Sci. Tech. 36:2147-2163 disclose the regeneration of activated carbon using ethanol or sodium hydroxide.

### DISCLOSURE OF INVENTION

We have discovered a simple, economical process for regenerating granular activated carbon. The novel regeneration process employs inexpensive compounds, and requires neither high temperatures nor ultraviolet radiation. It is well-suited to be implemented on-site. The novel process employs a combination of alcohol, alkali, and oxidant to regenerate GAC, preferably a solution of ethanol, alkali, and hydrogen peroxide.

In a preferred embodiment, used GAC is regenerated by washing with approximately one to three bed volumes of an aqueous solution of about 25% (v:v) ethanol, about 2% (m:m) NaOH, and about 0.1% (m:m) hydrogen peroxide (H₂O₂).

In a more preferred embodiment, the process employs the following sequential steps:
1. An optional acid wash step, typically using about one bed volume of about 2% to about 6%, preferably about 4% (m:m) aqueous HCl;
2. An optional washing step, typically using about one bed volume of about 1% to about 4%, preferably about 2% (m:m) aqueous NaOH;
3. Washing with approximately one to three bed volumes of a solution of about 20% to about 30%, preferably about 25% (v:v) ethanol; about 1% to about 4%, preferably about 2% (m:m) NaOH; and about 0.05% to about 0.5%, preferably about 0.1% (m:m) hydrogen peroxide (H₂O₂);
4. An optional post-regenerative wash with one bed volume of about 1% to about 4%, preferably about 2% (m:m) aqueous NaOH; and
5. An optional step of washing with water.

The novel alkali/ethanol/hydrogen peroxide step (e.g., Step 3 above) removes a surprisingly large amount of adsorbed colorant from spent GAC in comparison to other chemical GAC regeneration methods, and yields a regenerated GAC adsorption capacity nearly equal to that of fresh GAC.

The alcohol is preferably ethanol, but other alcohols such as methanol may also be used. (Methanol should generally not be used in the food industry, however.)

The alkali is preferably NaOH, but may also be other another base such as KOH.

The oxidant is preferably hydrogen peroxide, but may also be another oxidant, for example ozone, or a chlorine-based oxidant such as sodium hypochlorite.

The temperature at which the process is run may be any temperature at which the process works, preferably between about 20° C. and about 70° C., most preferably about 50° C.

The novel process may be employed in any setting where activated carbon is used. It is particularly well-suited for on-site regeneration of activated carbon that is used to decolorize sugar solutions (juices, syrups or liquors), in cane or beet sugar factories, sugar refineries, liquid sugar plants, or corn syrup factories.

Our economic estimates (not shown) have indicated that the novel method for regenerating GAC should be substantially less expensive than existing thermal regeneration methods.

The granular activated carbon is preferably contained within suitable columns or tanks. After it has been used to decolorize sugar solutions, the GAC is preferably first washed with water to remove sugar-containing juice in the column.

If calcium or magnesium is present, an acid wash, for example a 4% (m:m) hydrochloric acid solution, or other acid, may be passed through the carbon to remove adsorbed divalent cations prior to the regeneration step.

Following an acid wash it is preferred that a neutralization wash be used, for example using water followed by 2% (m:m) sodium hydroxide or other alkali.

Then the novel carbon regeneration step commences. This step involves washing the GAC with an aqueous regeneration solution containing: (1) an alcohol, preferably ethanol, at about 20% to about 30% (v:v), most preferably about 25%; (2) alkali, preferably sodium hydroxide, at about 1% to about 4% (m:m), most preferably about 2%; and (3) an oxidant, preferably hydrogen peroxide, at about 0.05% to about 0.5% (m:m), most preferably about 0.1%. The regenerant solution is preferably prepared shortly before use, as it may lose efficacy during long-term storage. The regenerant solution is passed through the carbon in down-flow or up-flow mode, depending on the equipment used.

The regeneration step is optionally (but preferably) followed by an alkaline wash, for example with 2% (m:m) sodium hydroxide or other alkali, and then by another wash with water.

Optionally, the ethanol used in the regeneration solution may be produced on site at a sugar mill. For example, in some countries, such as Brazil, a portion of the cane juice is often used to produce ethanol. The colored effluent produced by the regeneration step of the novel process, an effluent that already contains ethanol, may be mixed with fermented juice or molasses before distillation. Colorants in the effluent have the same chemical nature as colorants in juice or molasses and will not substantially affect ethanol production. Using this approach there is no environmental discharge of regeneration effluent per se.

### MODES FOR CARRYING OUT THE INVENTION

We have conducted prototype demonstrations to: (1) quantify the amount of adsorbed colorant removed from spent GAC by the novel process; and (2) compare the performance of regenerated GAC to that of fresh GAC.

### EXAMPLES 1-3

We compared the effectiveness of three wash solutions in removing colorant from spent GAC: (1) the novel hydrogen peroxide wash solution—specifically, 30% (v:v) ethanol, 2% (m:m) NaOH, and 0.1% (m:m) hydrogen peroxide (H₂O₂); (2) a solution containing 2% (m:m) NaOH and 30% (v:v) ethanol; and (3) an aqueous 2% (m:m) NaOH solution. Starting with fresh granular activated carbon (Calgon Activated Carbon, Type Cane Cal 12X40), 25 BV (bed volumes) of cane syrup at 10 brix were run through a jacketed column containing 100 ml of the GAC at 3 BV/hour at 70° C. The resulting spent GAC columns were treated separately with the three wash solutions passing through the GAC bed in down-flow at a rate of 2 BV/h. Samples were drawn from each column's wash effluent, filtered through a 1.2 μm filter, and the pH adjusted to 9.00±0.05. The effluent samples were placed in a 1 cm path-length optical cell, and absorbance was measured at 420 nm. The attenuancy entries below were calculated by multiplying the 420 nm absorbance by 1,000, after accounting for the distilled-water dilutions we made in order to obtain readings within the spectrophotometer's range. (The undiluted solutions were often quite dark.)

| | | | | Effluent |
|---|---|---|---|---|
| | Ethanol | NaOH | H₂O₂ | color |
| | (v:v) | (m:m) | (m:m) | attenuancy |
| Novel regeneration | 30% | 2% | 0.1% | 18,480 |
| solution | | | | |
| Alkalinized ethanol | 30% | 2% | 0% | 10,230 |
| solution | | | | |
| Aqueous NaOH solution | 0% | 2% | 0% | 3,520 |

The novel regeneration solution produced a substantially more highly colored effluent. It was superior in removing colored materials from cane sugar juices that had adsorbed onto the GAC.

Without wishing to be bound by this hypothesis, we believe that because of hydrogen peroxide's bleaching properties, these spectrophotometric measurements probably underestimated the regeneration efficacy of the novel wash solution. The hydrogen peroxide will bleach some color compounds, thus reducing apparent optical absorbance.

### EXAMPLES 4-6

Three one-liter portions of spent GAC, with adsorbed sugar colorants, were taken from the tests described in Example 22 (below), followed by two additional cycles with 300-400 BV juice at 2 BV/hour. The spent GAC was initially washed with water only. The GAC was placed in glass columns, and was regenerated with three regeneration solutions, under the conditions and procedures otherwise described for Examples 1-3. Desorption kinetics of this spent GAC were examined by sampling the effluent from three columns and measuring the color intensity spectrophotometrically at 420 nm, as otherwise described in Examples 1-3. The solutions were:
2% (m:m) aqueous NaOH;
25% (v:v) ethanol +2% (m:m) NaOH; and
A variation of the novel regeneration solution used in Example 1, in which we reduced the ethanol concentration to 25% (v:v), but left the NaOH and H₂O₂ concentrations unchanged: 2% (m:m) NaOH and 0.1% (m:m) H₂O₂.
   A 1 BV quantity of all solutions was used, preceded by a 1 BV 2% (m:m) NaOH alkali wash, and also followed by a 1 BV 2% (m:m) NaOH alkali wash.

Samples were taken every 10 minutes, starting 30 minutes after the first alkali wash. After filtration through a 1.2 μm filter, sample aliquots were adjusted to pH 9.00±0.05, and optical absorbance measurements were made in a 1 cm cell at 420 nm. The colors of the regeneration effluents, in attenuancy values, are presented in Table 1.

TABLE 1

| Bed | | | |
|---|---|---|---|
| Volumes | NaOH | EtOH + | EtOH + NaOH + |
| of effluent | wash | NaOH wash | H₂O₂ wash |
| 1.00 | 12,494 | 2,323 | 6,104 |
| 1.25 | 42,124 | 31,430 | 36,686 |
| 1.50 | 51,536 | 60,715 | 59,467 |
| 1.75 | 46,090 | 65,585 | 80,664 |
| 2.00 | 42,652 | 90,733 | 172,745 |
| 2.25 | 38,587 | 106,344 | 149,517 |
| 2.50 | 33,790 | 93,852 | 68,953 |
| 2.75 | 28,559 | 69,547 | 31,310 |
| 3.00 | 19,480 | 16,091 | 18,742 |
| 3.25 | 16,191 | 15,085 | 13,257 |
| 3.50 | 14,875 | 6,090 | 13,640 |
| 3.75 | 13,986 | 5,111 | 10,678 |
| Average | 30,030 | 47,864 | 55,147 |

Carbon that had been regenerated by the novel process removed far more color compounds than did carbon that had been treated either with NaOH alone or with NaOH+ethanol. Under the assumption that the integrated area under each of the attenuancy profiles was proportional to the amount of desorbed material, we found the relative efficacy of the aqueous NaOH wash, the ethanolic NaOH wash, and the novel regenerant solution to be in the ratio 1.00:1.64:1.94. For the reasons previously given (bleaching by H₂O₂), this ratio likely understates the true efficacy of the novel regenerant solution.

### EXAMPLES 7-14

We evaluated the adsorptivity of GAC regenerated with the novel solution. These experiments were conducted at the pilot plant scale at a Louisiana cane sugar mill, starting with 17 liters of fresh granular activated carbon (Calgon Activated Carbon, Type Cane Cal 12X40) packed in a glass column.

The GAC-loaded column was used to decolorize clarified cane juice specimens of varying composition, e.g., different color (measured in IU or ICUMSA units), and different solids concentration (measured in mass percent of dissolved solids, or “brix”). Eight decolorization cycles were conducted, with volumes ranging from 96 to 216 BV (bed volumes) (1,632 to 3,672 L) at a uniform flow rate of 1 BV/hour. After each of the eight cycles, the GAC was washed with water and treated with 1 bed volume (BV) of 2% (m:m) aqueous NaOH, followed by 1 BV of the novel solution (25% (v:v) ethanol, 2% (m:m) NaOH, 0.1% (m:m) H₂O₂ at 50° C., at a flow rate of 2 BV/h. The peroxide wash was followed by another BV wash of 2% (m:m) aqueous NaOH, and then a final water wash.

Results are summarized in Table 2.

TABLE 2

| | | | | | | | | | % Color |
|---|---|---|---|---|---|---|---|---|---|
| | Feed | | Clarified juice | | | Decolorized juice | | | Decrease |
| Cycle | BV | BV/h | brix | Color IU | pH | brix | Color IU | pH | IU |
| 1 | 96 | 1 | 13.35 | 7,813 | 6.4 | 13.20 | 789 | 4.1 | 89.9 |
| 2 | 120 | 1 | 13.72 | 10,840 | 7.9 | 13.43 | 1,838 | 6.1 | 83.0 |
| 3 | 120 | 1 | 14.18 | 21,059 | 8.7 | 13.34 | 2,423 | 4.5 | 88.5 |
| 4 | 168 | 1 | 14.14 | 12,252 | 8.6 | 13.85 | 2,426 | 5.6 | 80.2 |
| 5 | 144 | 1 | 14.06 | 14,034 | 8.6 | 13.34 | 2,583 | 4.5 | 81.6 |
| 6 | 216 | 1 | 14.51 | 14,128 | 8.4 | 14.74 | 5,382 | 5.9 | 61.9 |
| 7 | 120 | 1 | 12.15 | 17,465 | 8.4 | 11.20 | 6,436 | 5.3 | 63.1 |
| 8 | 120 | 1 | 13.62 | 12,148 | 8.0 | 13.11 | 1,418 | 5.0 | 88.3 |
| Average | 138 | 1 | 13.72 | 13,717 | 8.1 | 13.28 | 2,912 | 5.1 | 78.8 |

As shown in Table 2, an average 79% decolorization (in ICUMSA color units) was achieved over eight cycles. This consistently high decolorization showed that the novel GAC regeneration process was highly effective in restoring the performance of spent GAC.

### EXAMPLES 15-22

Another pilot plant trial was conducted at a Louisiana cane sugar mill. In this test, separate 15 liter and 30 liter glass columns were filled with fresh GAC (Calgon Activated Carbon, Type Cane Cal 12X40) and connected in series, so that juice flowed first through the 15-liter section, and then through the 30-liter section. The juice flow could readily be sampled at the connection between the 15 and 30 liter sections, and also at the end of the combined column. Thus spectrophotometric and chemical assays of the juices could be conducted one-third of the way through the combined column, as well as at the end of the combined column. Clarified juice at a flow of 1 to 2 BV/h was fed to the combined GAC columns in a total volume of 100 to 120 BV/cycle. Clarified juices of average color 9,274 IU were treated with GAC. An average decolorization of 76% was achieved.

Following each cycle, the carbon was regenerated with the novel regeneration solution as previously described, at 2 BV/h, but in reverse order; i.e., fresh regeneration solution was first pumped into the 30-liter column, and upon exiting was immediately fed into the 15-liter column.

Table 3 presents the composition of the clarified juice used in this set of experiments, the composition of the juice following the first, 15-liter column (“Juice after Pre column”), and the composition of the juice following the second, 30-liter column (“Juice after GAC column”). The information presented in Table 3 includes the percentage of dissolved solids (brix); acidity (pH); and color (ICUMSA units). Note that the total percentage of dissolved solids (brix) changed little; that the first column reduced the pH somewhat, with the second column not changing pH much; and that both columns removed substantial amounts of color. (pH typically drops in a pure carbon column. Sometimes magnesite is added to buffer the pH.)

TABLE 3
Analysis of Clarified Juice, and of Juices after
the Pre-column, and after the GAC column

| | Clarified juice | | | Juice after Pre column | | | Juice after GAC column | | |
|---|---|---|---|---|---|---|---|---|---|
| Cycle | | Color | | | Color | | | Color | |
| # | Brix | IU | pH | Brix | IU | pH | Brix | IU | pH |
| 1 | 15.15 | 12,160 | 6.82 | 16.7 | 2,650 | 4.82 | 14.43 | 1,230 | 5.53 |
| 2 | 15.42 | 10,157 | 6.94 | 15.27 | 5,814 | 4.84 | 14.79 | 819 | 5.15 |
| 3 | 15.3 | 8,736 | 7.45 | 15.04 | 6,164 | 5.4 | 14.78 | 512 | 6.51 |
| 4 | 14.73 | 8,655 | 8.04 | 14.59 | 6,193 | 5.43 | 14.3 | 1,356 | 5.8 |
| 5 | 14.02 | 11,810 | 7.56 | 13.31 | 10,166 | 5.33 | 13.5 | 2,303 | 5.16 |
| 6 | 14.62 | 7,397 | 8.42 | 14.7 | 7,150 | 6.05 | 14.48 | 1,870 | 5.39 |
| 7 | 12.51 | 8,006 | 8.11 | 13.03 | 7,966 | 6.2 | 13.2 | 2,939 | 5.34 |
| 8 | 13.62 | 7,270 | 8.37 | 13.79 | 7,171 | 6.44 | 14.25 | 4,966 | 5.38 |
| Average | 14.42 | 9,274 | 7.71 | 14.55 | 6,659 | 5.56 | 14.22 | 1,999 | 5.53 |

Table 4 presents percentage change in juice color for the first (15 L) column, the second (30 L) column, and the overall decolorization from both columns.

TABLE 4
Juice decolorization on the Pre-column (First),
GAC Column (Second), and on both columns (Total)

| | % of decolorization on Carbon | | |
|---|---|---|---|
| Cycle | Columns (based on IU color) | | |
| # | First | Second | Total |
| 1 | 78.2 | 53.6 | 89.9 |
| 2 | 42.8 | 85.9 | 91.9 |
| 3 | 29.4 | 91.7 | 94.1 |
| 4 | 28.4 | 78.1 | 84.3 |
| 5 | 13.9 | 77.3 | 80.5 |
| 6 | 3.3 | 73.8 | 74.7 |
| 7 | 0.5 | 63.1 | 63.3 |
| 8 | 1.4 | 30.7 | 31.7 |
| Average | 24.7 | 69.3 | 76.3 |

The consistently high total decolorization obtained with the combined columns confirmed the efficacy of our novel hydrogen peroxide wash solution in regenerating spent GAC. It was evident from the steadily deteriorating performance of the first column segment, which was fed the spent regenerant from Column 2 during the regeneration cycle, that the regeneration solution was depleted after passage through the second column. Thus it is preferred in practice to deploy fresh regeneration solution as frequently as needed, or in sufficient overall quantities, or where needed, to ensure that all GAC is effectively regenerated. The results in Table 4 showed the regenerated GAC gave excellent performance through at least seven regeneration cycles. There was an anomalous deterioration of GAC performance in the eighth cycle, which we believe to have resulted from an unusual impurity in the feed juice.

### Miscellaneous

The complete disclosures of all cited references are hereby incorporated by reference. Also incorporated by reference is the complete disclosure of the priority application, U.S. provisional patent application Ser. No. 60/717,410, filed 14 Sep. 2005.

What is claimed:

1. A process for regenerating used activated carbon, comprising contacting the used activated carbon with a regenerating solution for a time, in an amount, and in a concentration sufficient to restore a substantial portion of the carbon's ability to adsorb other compounds; wherein the regenerating solution comprises an aqueous solution of an alcohol, an alkali, and an oxidant.

2. A process as recited in claim 1, wherein the regenerating solution comprises an aqueous solution of ethanol, sodium hydroxide, and hydrogen peroxide.

3. A process as recited in claim 1, wherein the regenerating solution comprises an aqueous solution of about 20% to about 30% (v:v) ethanol, about 1% to about 4% (m:m) sodium hydroxide, and about 0.05% to about 0.5% (m:m) hydrogen peroxide; and wherein said contacting step is conducted at a temperature between about 20° C. and about 70° C.

4. A process as recited in claim 1, wherein the regenerating solution comprises an aqueous solution of about 25% (v:v) ethanol, about 2% (m:m) sodium hydroxide, and about 0.1% (m:m) hydrogen peroxide; and wherein said contacting step is conducted at a temperature of about 50° C.

5. A process as recited in claim 1, additionally comprising the step, prior to said regenerating step, of producing used activated carbon by contacting activated carbon with clarified sugar juice, wherein the activated carbon adsorbs color compounds from the sugar juice; and also additionally comprising the step, following said regenerating step, of contacting the regenerated activated carbon with clarified sugar juice to cause color compounds from the sugar juice to be adsorbed onto the regenerated activated carbon; wherein the ability of the activated carbon to adsorb color compounds during the latter step of contacting with clarified sugar juice is substantially greater than would be the case in the absence of said regenerating step.
